(19) United States
(12) Patent Application Publication
(10) Pub. No.: US 2005/0103542 A1
(43) Pub. Date: May 19, 2005

(54) Gas-electric hybrid drive system with a planetary gear

(76) Inventor: Wallace W. Grabbe, Costa Mesa, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 10/717,031

(22) Filed: Nov. 18, 2003

(51) Int. Cl. B60K 6/04

(52) U.S. Cl. 180/65.2

(57) ABSTRACT

A gas-electric hybrid drive system for a vehicle, includes a first drive train including an input shaft, an output shaft and an electric motor generator interconnecting the input and output shafts with a one to one torque ratio. A planetary gear set is disposed between the electric motor generator and the input shaft, the planetary gear set maintaining the one to one torque ratio between the input shaft, the electric motor generator and the output shaft. A second drive train includes an electric generator interconnected to the output shaft through the planetary gear set and a battery pack is connected to both the first and second motor generator and generator. A controller is provided for causing the generator to provide torque to the output shaft through the motor generator and the planetary gear set for acceleration of output shaft RPM and to charge the battery pack during deceleration and steady state output shaft RPM and for causing said motor generator to utilize excess torque of said input shaft to charge said battery pack.

The present invention generally relates to a vehicle drive system and more particularly is directed to hybrid drive systems.

If a hybrid vehicle is designed to routinely stay within its battery range, then a large battery pack is necessary. However, when a vehicle routinely travels beyond the range of its battery pack, then a minimal size battery pack is preferable. Such a system would feature a gas engine, sized and geared for maximum efficiency while cruising, (not for acceleration) and could even be placed in a midsized or large automobile. This unique electrical power system, along with a small battery pack, could make a vehicle into a very desirable performance vehicle, and at the same time, an extremely fuel-efficient vehicle, with a lot of environmental advantages or “greenness”.

If this small battery pack provides for a range of about five or ten miles, most trips to the local markets could be made without even starting the gas-engine and the automobile could travel to and from the freeway on battery power alone. The weight and cost reduction would be significant and other “environmental” and cost problems associated with the batteries would be reduced.

The present invention, sometimes hereinafter referred to as the “Grabb Transmission”, provides for such a hybrid drive system.

The “Grabb Transmission” system would equally benefit the conventional hybrid system with the large battery pack, by adding features of simplicity and efficiency.

### SUMMARY OF THE INVENTION

A gas-electric hybrid drive system for a vehicle in accordance with the present invention generally includes a first drive train including an input shaft, an output shaft and an electric motor generator interconnecting the input and output shafts with a one to one torque ratio.

A planetary gear set is provided and disposed between the electric motor generator and the input shaft with the planetary gear set maintaining the one to one torque ratio between the input shaft, the electric motor generator, and the output shaft.

A second drive train including an electric generator is interconnected to the output shaft through the planetary gear set.

A battery pack is electrically connected to both the motor generator and generator and a controller causes the generator to provide torque to the output shaft through the motor generator and the planetary gear set for acceleration of output shaft RPM and to charge the battery pack during deceleration and steady state output shaft RPM. In addition, the controller causes the motor generator to utilize excess torque of the input shaft to charge the battery pack.

An engine, for example, a gasoline engine, and a throttle controller is provide for controlling the engine RPM in order to provide added input shaft torque. The throttle control may be connected to the controller for providing input thereto in order for the controller to cause the added torque and battery pack charging during acceleration, deceleration, and steady output shaft RPM.

### BRIEF DESCRIPTION OF THE DRAWING

The advantages and features of the present invention will be better understood by the following description when considered in conjunction with the accompanying drawing in which:

FIG. 1 is a block diagram of the gas-electric hybrid drive system in accordance with the present invention.

### DETAILED DESCRIPTION

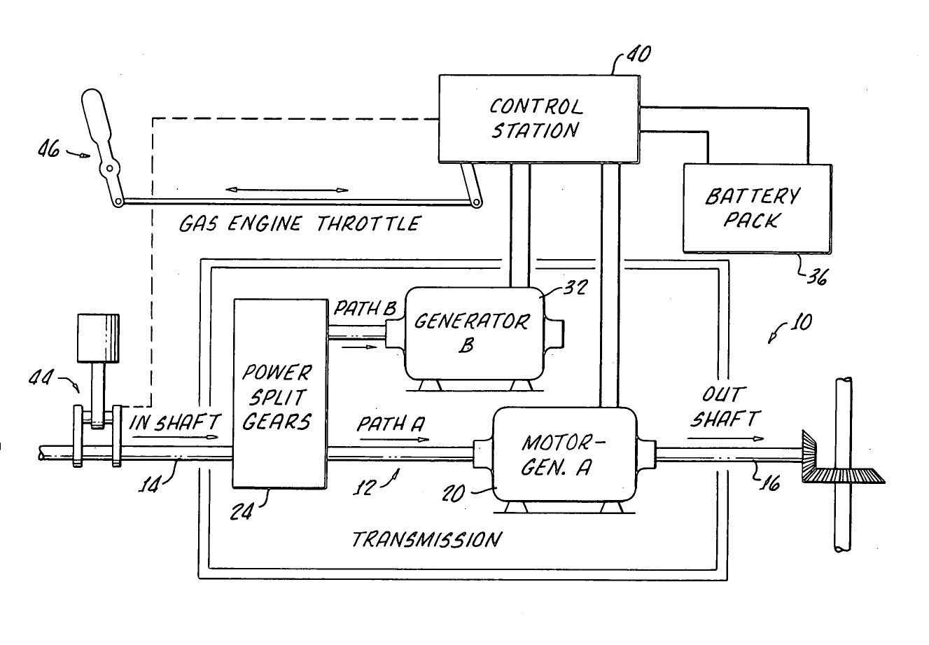

With reference to FIG. 1 there is shown a gas-electric hybrid drive system 10 in accordance with the present invention for a vehicle (not shown).

A first drive train 12 includes an input shaft 14, an output shaft 16 and a first electric motor generator 20 interconnecting the input and output shafts 14, 16 with a one to one torque ratio.

A planetary gear set 24 is disposed between the electric motor generator 20 and the input shaft 14 with the planetary gear set 24 maintaining the one to one torque ratio between the input shaft 14, the electric motor generator 20 and the output shaft 16.

A second drive train 30 includes a generator 32 interconnected to the input shaft 14 through the planetary gear set 24. A battery pack 36 is electrically connected to both the first and second generators through a controller 40.

The controller 40 causes the electric generator 32 to provide torque to the output shaft 16 through the motor generator 20 and the planetary gear set 24 for acceleration of output shaft RPM and to charge the battery pack 36 during the deceleration and steady state output shaft RPM and additionally causing the motor generator 20 to utilize excess torque of the input shaft 14 to charge the battery pack.

An engine 44, preferably gasoline, is utilized to rotate the input shaft 14 and a throttle control 46 enables the control of engine RPM in order to provide added input shaft torque. The throttle control 46 is connected to the controller 40 to cause the added torque and battery pack charging during acceleration, deceleration and steady output shaft RPM.

Economy Features:

1. This “transmission” can keep the efficiency of the gas-engine high, even during the slow speed of city driving. It can keep the engine manifold pressure high by adding the load of charging batteries. This can create maximum fuel efficiency for charging the batteries, as well as for slow cruising in the city.

2. The efficiency of a gas-engine with this “transmission” can not only approach the efficiency of a diesel engine by maintaining a high compression ratio, it can also keep the compression ratio low enough to avoid the intolerable production of oxides of nitrogen, which is a problem with the diesel engine.

3. Gearing in the differential determines the engine “gearing to the road”. This gearing is “tuned” to produce automobile driving characteristics somewhere between maximum road performance and maximum fuel efficiency (overdrive). Automobiles are not “tuned” too close to the efficiency end, because the driving characteristics would be to “wimpy”. With the Grabb “Transmission”, this “wimpiness” is not a problem. When throttle is added during cruising, torque, by way of electric motor 20, is also added automatically, and with the same smoothness as adding throttle alone.

4. The “stick shift” transmission is the most efficient system for cruising. The cruising power is delivered from the engine, through the transmission to the differential in one continuous mechanical shaft. The Grabb “Transmission” uses the same principal in the cruising phase.

5. The elimination of the weight of the geared transmission and some of the battery pack will contribute to fuel efficiency.

Environmental (Green) Features:

1. This “transmission” accommodates accumulative breaking, which not only saves some fuel, but also the expense of relining, and minimizes the “green” problem of brake lining particle pollution.

2. As all electric vehicles, this vehicle is very “clean” when creeping freeway conditions exists, for fast food lines, and for the stop and go traffic of city driving.

### Dynamics

This invention uses a planetary gear set to control movement of the gas engine power between a cruising mode “A” and an accelerating mode “B”, see FIG. 1.

The system consists of an ever present “A” mode (like “high gear” in a stick shift transmission), and an electric accelerating “B” mode, that can boast the torque of the “A” mode when needed.

The two systems are brought together in the transmission “out shaft” to proceed as one to propel the vehicle.

The Cruising “A” Mode:

The stick shift transmission “high gear” is the simplest and most efficient “cruising” system for an automobile. The Grabb “transmission” uses the same direct drive system, with a fixed torque ratio of one to one with the gas-engine, for its cruising mode.

The transmission cruising “A” mode is ever present and ever active and never changes from its straight through, one to one, drive mode, even when the vehicle comes to a stop. Even though the “A” mode would have zero RPMs and thus have zero power at that point and couldn't contribute to powering the vehicle.

This cruising “A” mode maintains its one to one torque ratio during the complete range of its transmission activity, from a “stand still” to top speed. So at “stand still”, the cruising mode can contribute a force of one engine torque, but zero power.

When the vehicle starts to move, it receives almost no power from the “A” cruise system. When the vehicle gains a speed of about twenty to thirty miles per hour—depending on the throttle setting—the “A” cruise system might have gained enough RPMs, and thus, enough power to propel the vehicle without the aid of the “B” accelerating mode.

The cruising “A” mode will have reached its maximum power when the vehicle reaches its maximum speed. The “A” mode is ever present, but starts with none of the gas-engine power and ends up at high speed, with all of the gas-engine power.

The cruising mode is always a major part of the power expended on acceleration, and therefore adds efficiency to the electric accelerating process.

Accelerating “B” Mode:

The gas engine is sized and geared for maximum fuel economy while cruising in the “A” mode. This makes cruising very fuel efficient, but also makes it inadequate to handle any but the least acceleration or grade climbing without assistance. When the vehicle needs extra power, throttle is added, the “A” mode will gain some torque, but then cannot accept more power because of the limited speed of the vehicle drive wheels. Any extra power, then, will be delivered by the split gear system to the “B” acceleration mode. The “B” mode consists of an electric generator and an electric motor. The electric motor will convert the electric energy back to mechanical energy, and send it to the drive wheels to join the “A” cruising torque, where the two forces will join and cause the vehicle to accelerate.

Although the planetary gear system gives a preference to the “A” path, when the “A” path has received all of the RPMs (power) that the vehicle speed will allow, the planetary gears will deliver the excess power to the “B” path—the accelerating path. As some or all of the mechanical power of the gas-engine is accepted by the “B” path, that power is converted to electric power by the “B” generator. The electric power is converted back to mechanical power by the electric motor. The “B” path power is joined with the “A” path power in the transmission “out shaft” and the two together propel the vehicle as one force.

At the moment that the vehicle starts to move, the accelerating “B” phase has access to all of the engine power because the “A” phase cannot use any power when the drive wheels are not moving. The “A” phase has top priority on the gas-engine power only when it can use it. So, as the vehicle gains speed, the cruising forces increase. The accelerating forces, being limited to what power is left, diminishes, and is phased out (ceases to exist) when the cruising forces get strong enough to propel the vehicle alone.

The “A” path is always engaged, as long as the transmission is in the drive mode. The “B” path is only active when the “A” path has to divert power, because the drive wheels are rotating to slow for the gas engine speed.

The cruising torque is fixed at one to one with the gas engine. The accelerating torque, when it exists, is variable, because the generated electricity that creates it is variable, and thus creates a continuously variable transmission.

The “A” path is the one propelling force during cruising, and it is a part of the propelling force during acceleration.

When the vehicle is cruising and throttle is added to “kick in” the accelerating mode, the sensation of dropping back a gear is not there. The sensation is that more throttle was added to a stronger gas-engine.

Path “A” generates one times the gas-engine torque. Path “B” adds one or more engine torques, depending on the design of the electric motor.

Planetary Gear Balancing:

The gas engine power going through the planetary gear system will take the path of least resistance. Gearing path “A” a little lower than path “B” will make the power favor the “A” path. There are times however, when the path must be modified. Generator “A: is in the “A” path and generator “B” is in the “B” path. The selective degree of the use of the two generators can control the balance of the two paths with the mechanical resistance they each generate.

Battery Power:

When the batteries are to be charged, extra power is added to the gas-engine. Generator “A”, or, (or and), generator “B” is adjusted to generate the current for the batteries at anytime during travel or when stationary.

The battery power, through the electric motor, can create cruising power, for creeping freeway driving, for fast food lines, or for street traffic in the city or on the way to or from the freeway. It can also add power to the accelerating “B” path, when extreme power is called for.

During slow cruising, the battery charging can be used to add a load that raises the manifold pressure, making the gas-engine operate with maximum efficiency for charging the batteries and for cruising.

### Construction

Planetary Gear Set;

The gas-engine power is split into two paths by the planetary gears. Path “A” is for cruising, it connects the gas-engine to the drive wheel by way of a straight through shaft. Path “B” is for acceleration, it connects the gas-engine to the “B” generator, which generates current for charging the battery pack, or, (or and), powering the electric motor so more torque can be sent to the drive wheels.

Electric Motor:

The electric motor generates torque with current from the “B” generator. This torque is accelerating torque from the “B” system and joins the cruising “A” torque in the electric motor shaft, which is also the transmission out shaft. The two systems “A” and “B” join to power the vehicle as one force.

Generator “A”:

The electric motor is a combination electric motor and generator “A”. Generator “A” is necessary for accumulative breaking and the mechanical resistance it generates plays a part in the balancing the forces between path “A” and path “B” within the planetary gears.

The Battery Pack:

The large battery pack is the primary supplier of energy for the conventional type of gas-electric hybrid vehicle. A small battery pack would serve a proposed new design of a gas-electric hybrid vehicle that is propelled primarily with the gas-engine, and uses battery power to create added efficiency.

Although there has been hereinabove described a specific gas-electric hybrid drive system with a planetary gear in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

1. A gas-electric hybrid drive system for a vehicle, the system comprising:
a first drive train including an input shaft, an output shaft and an electric motor generator interconnecting the input and output shafts with a one to one torque ratio;
a planetary gear set disposed between said first electric motor generator and said input shaft, said planetary gear set maintaining the one to one torque ratio between said input shaft, said first electric motor generator and said output shaft;
a second drive train including an electric generator interconnected to said output shaft through said planetary gear set;
a battery pack electrically connected to both the motor generators and generator; and
a controller for causing said generator to provide torque to said output shaft through the motor generator and said planetary gear set for acceleration of output shaft RPM and to charge said battery pack during deceleration and steady state output shaft RPM and for causing said motor generator to utilize excess torque of said input shaft to charge said battery pack.

2. The system according to claim 1 further comprising an engine for driving said input shaft.

3. The system according to claim 2 further comprising a throttle control for controlling engine RPM input shaft torque.

4. The system according to claim 3 wherein said throttle control is connected to said controller for providing input thereto in order for the controller to effect battery pack charging during acceleration, deceleration and steady output shaft RPM.

5. The system according to claim 4 wherein said engine is a gasoline engine.

6. A gas-electric hybrid drive system for a vehicle, the system comprising:
a first drive train including an input shaft, an output shaft and a electric motor generator interconnecting the input and output shafts with a one to one torque ratio;
a planetary gear set disposed between said electric motor generator and said input shaft, said planetary gear set maintaining the one to one torque ratio between said input shaft, said electric motor generator and said output shaft;
a second drive train including an electric generator interconnected to said output shaft through said planetary gear set;
an engine interconnected with said input shaft;
a battery pack electrically connected to both the motor generator and generator; and
a controller for causing said generator to provide torque to said output shaft through the motor generator and said planetary gear set for acceleration of output shaft RPM and to charge said battery pack during deceleration and steady state output shaft RPM and for causing said motor generator to utilize excess torque of said input shaft to charge said battery pack.

7. The system according to claim 6 further comprising a throttle control for controlling engine RPM input shaft torque.

8. The system according to claim 7 wherein said throttle control is connected to said controller for providing input thereto in order for the controller to effect battery pack charging during acceleration, deceleration and steady output shaft RPM.

9. The system according to claim 8 wherein said engine is a gasoline engine.
